(19) United States
(12) Patent Application Publication
(10) Pub. No.: US 2006/0245210 A1
(43) Pub. Date: Nov. 2, 2006

(54) Backlight module and liquid crystal display having same

(75) Inventors: Ching Huang Lin, Miao-Li (TW); Bing Ai, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/414,926

(22) Filed: May 1, 2006

(30) Foreign Application Priority Data
Apr. 29, 2005 (TW) 94206890

(51) Int. Cl. F21V 8/00

(52) U.S. Cl. 362/612; 362/606

(57) ABSTRACT

An exemplary backlight module (20) includes a light guide plate (21), a plurality of point light sources (22), and a transparent light diffusing element (23). The light guide plate includes a light incident surface (211). The point light sources are positioned adjacent to the light incident surface. The light diffusing element is positioned between the point light sources and has a light incident surface. The light diffusing element includes a plurality of recesses (231) which face the light incident surface and correspond to the point light sources. The light diffusing element can diffuse light from the point light sources, therefore increasing emitting angles of the point light sources. The recesses of the light diffusing element can make light from the point light sources more uniform.

### FIELD OF THE INVENTION

The present invention relates to backlight modules and liquid crystal displays having a backlight module.

### GENERAL BACKGROUND

A typical liquid crystal display is capable of displaying a clear and sharp image through millions of pixels that make up the complete image. The liquid crystal display has thus been applied to various electronic equipment in which messages or pictures need to be displayed, such as mobile phones and notebook computers. However, liquid crystals in the liquid crystal display do not themselves emit light. Rather, the liquid crystals have to be lit up by a backlight module so as to clearly and sharply display text and images.

A backlight module typically includes a light source and a light guide element such as a light guide plate. Generally, in large size backlight modules, cold cathode fluorescent lamps (CCFLs) are used as light sources. However, because CCFLs include mercury (Hg) which can be harmful to people's health, CCFLs are prohibited in many countries.

Nowadays, large size backlight modules are generally so-called direct-type backlight modules. Referring to FIG. 9, a typical direct-type backlight module 10 includes a light guide plate 11 and a plurality of point light sources 12 underneath the light guide plate 11. The point light sources 12 are light emitting diodes (LEDs).

However, the LEDs generally have a small light emitting angle, and so the light guide plate tends to exhibit a plurality of light spots thereon. Thus the uniformity of light provided by the backlight module may be unsatisfactory.

Therefore, a new backlight module and a liquid crystal display that can overcome the above-described problems are desired.

### SUMMARY

A backlight module includes a light guide plate, a plurality of point light sources, and a transparent light diffusing element. The light guide plate includes a light incident surface. The point light sources are positioned adjacent to the light incident surface. The light diffusing element is positioned between the point light sources and has a light incident surface. The light diffusing element includes a plurality of recesses which face the light incident surface and correspond to the point light sources. The light diffusing element can diffuse light from the point light sources, therefore increasing emitting angles of the point light sources. The recesses of the light diffusing element can make light from the point light sources more uniform.

Other advantages and novel features will become more apparent from the following detailed description when taken in conjunction with the accompanying drawings. All the views in the drawings are shown schematically.

### BRIEF DESCRIPTION OF THE DRAWINGS

FIG. 1 is an exploded, isometric view of a backlight module according to a first embodiment of the present invention.

FIG. 2 is a cross-sectional view taken along line II-II of FIG. 1.

FIG. 3 is a top plan view of a backlight module according to a second embodiment of the present invention, showing essential optical paths thereof.

FIG. 4 is an enlarged, cross-sectional view of a light diffusing element of a backlight module according to a third embodiment of the present invention.

FIG. 5 is an enlarged, cross-sectional view of a light diffusing element of a backlight module according to a fourth embodiment of the present invention.

FIG. 6 is a top cross-sectional view of a backlight module according to a fifth embodiment of the present invention.

FIG. 7 is a top plan view of a backlight module according to a sixth embodiment of the present invention.

FIG. 8 is an exploded, isometric view of a liquid crystal display according to a seventh embodiment of the present invention, the liquid crystal display including the backlight module of FIG. 1.

FIG. 9 is a side view of a conventional backlight module.

### DETAILED DESCRIPTION OF PREFERRED EMBODIMENTS

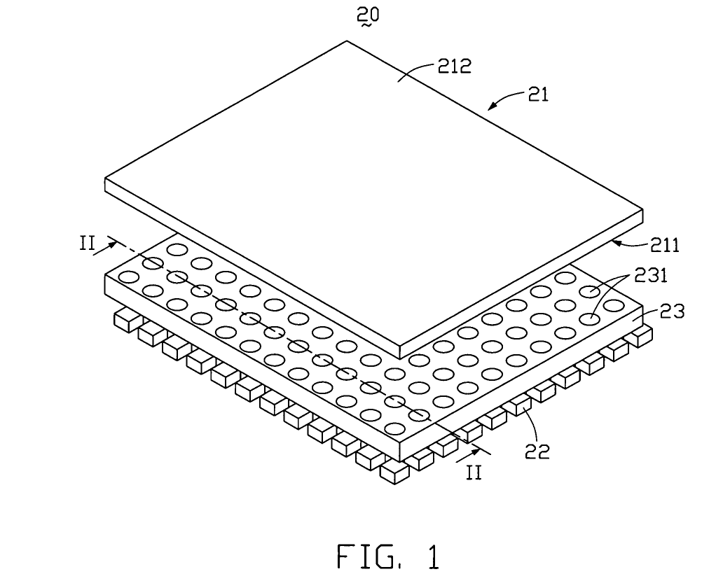

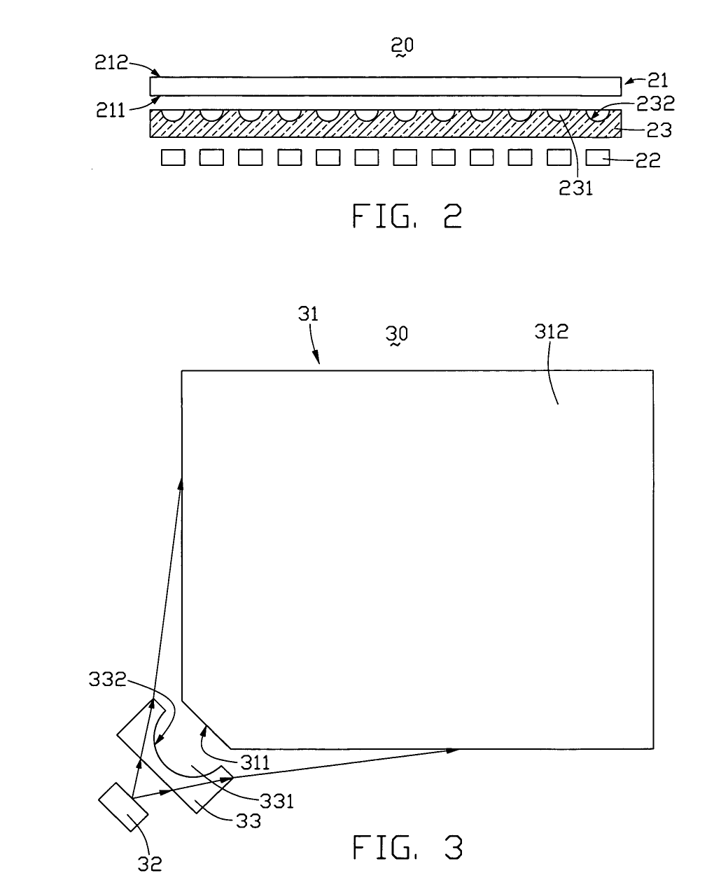

Referring to FIGS. 1 and 2, a backlight module 20 according to a first embodiment of the present invention includes a light guide plate 21 having a light incident surface 211 and a light emitting surface 212, a plurality of point light sources 22 below the light incident surface 211, and a light diffusing element 23 interposed between the light guide plate 21 and the point light sources 22. The light guide plate 21 is rectangular. The point light sources 22 are preferably light emitting diodes (LEDs), and are arrayed in a matrix. The light diffusing element 23 is transparent and rectangular. The light diffusing element 23 includes a plurality of hemispherical recesses 231, which face the light incident surface 211 and respectively correspond to the plurality of point light sources 22. Each recess 231 has a smooth inner surface 232.

The light diffusing element 23 can diffuse light from the point light sources 22, therefore effectively increasing light emitting angles of the point light sources 22. Because the light diffusing element 23 is provided, the number of point light sources 22 can be decreased, so that a cost of the backlight module 20 is reduced. Further, the hemispherical recesses 231 of the light diffusing element 23 can make the light from the point light sources 22 more uniform. Moreover, the light diffusing element 23 can reflect light leaking from the light guide plate 21 back into the light guide plate 21, thereby increasing a brightness of the backlight module 20.

Referring to FIG. 3, a backlight module 30 according to a second embodiment of the present invention includes: a light guide plate 31 having a light incident surface 311 located at a corner thereof, and a light emitting surface 322 perpendicularly adjoining the light incident surface 311; a point light source 32 positioned opposite to the light incident surface 311; and a light diffusing element 33 interposed between the point light source 32 and the light incident surface 311. The light diffusing element 33 is generally rectangular, transparent, and is preferably made from titanium oxide (TiO₂). The light diffusing element 33 includes a semicylindrical recess 331, which faces the light incident surface 311 and corresponds to the point light source 32. The recess 331 has a smooth inner surface 332.

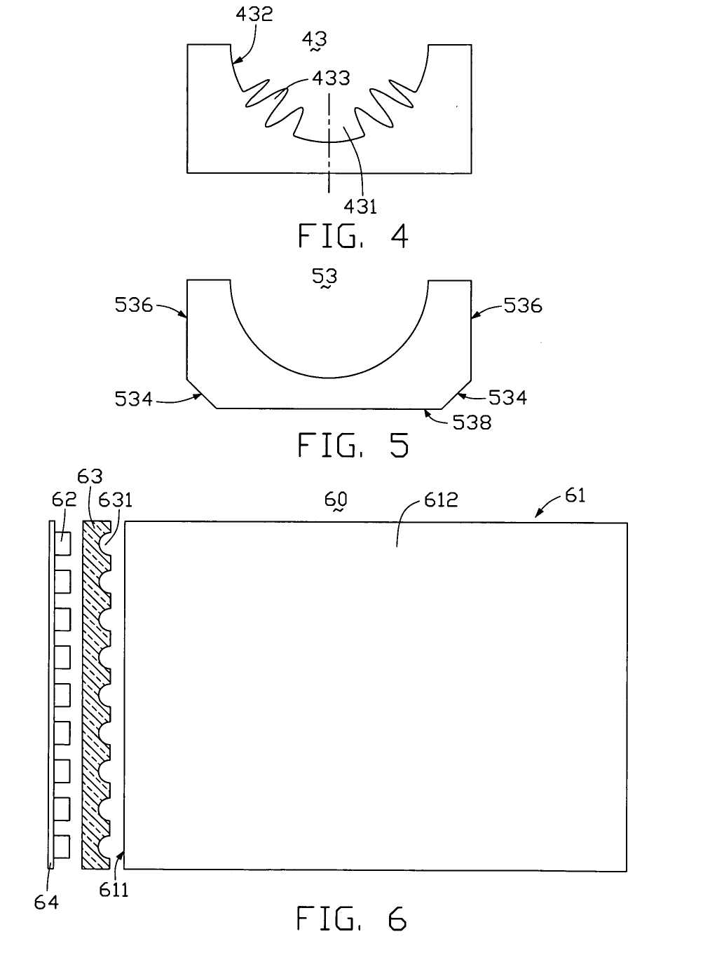

Referring to FIG. 4, a backlight module according to a third embodiment of the present invention is similar to the backlight module 30, except that a light diffusing element 43 includes a plurality of protrusions 433 symmetrically disposed at an inner surface 432 of a recess 431. Heights of the protrusions 433 as measured from the inner surface 432 are in the range from 0.3˜0.5 times a radius of a semicircular cross-section defined by the recess 431. The protrusions 433 can make light emitting from the light diffusing element 43 more uniform.

Referring to FIG. 5, a backlight module according to a fourth embodiment of the present invention is similar to the backlight module 30. However, a light diffusing element 53 further includes two oblique portions 534. The oblique portions 534 interconnect a light receiving surface 538 and two opposite side surfaces 536 perpendicular to the light receiving surface 538 respectively. The oblique portions 534 can reflect light leaking from or reflected off of a light guide plate (not shown) that is disposed adjacent to the light diffusing element 53. That is, the oblique portions 534 reflect such light back into the light guide plate, thereby increasing a light utilization ratio of the backlight module.

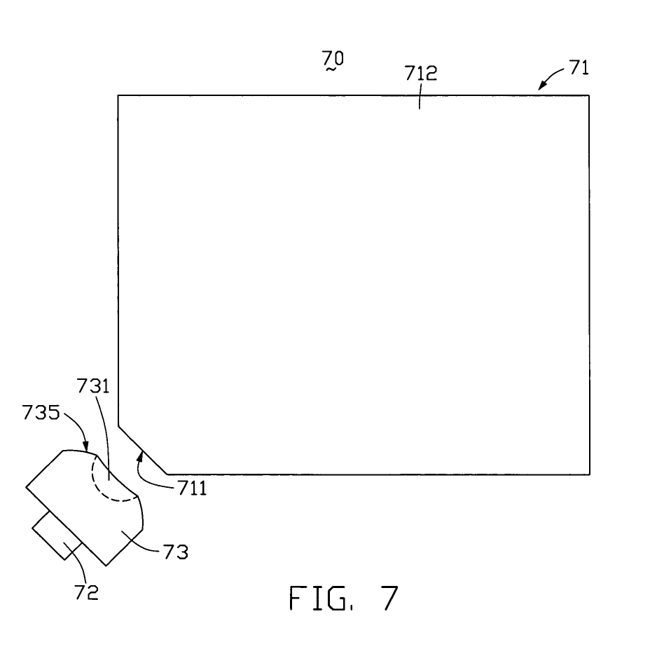

Referring to FIG. 6, a backlight module 60 according to a fifth embodiment of the present invention includes: a light guide plate 61 having a light incident surface 611, and a light emitting surface 612 perpendicularly adjoining the light incident surface 611; a plurality of point light sources 62 positioned opposite to the light incident surface 611; an integrated circuit (IC) board 64 for supporting the point light sources 62 and supplying power to the point light sources 62; and a rectangular light diffusing element 63 interposed between the point light sources 62 and the light incident surface 611. The light diffusing element 63 includes a plurality of semicylindrical recesses 631, which face the light incident surface 611 and respectively correspond to the plurality of point light sources 62. Each recess 631 has a smooth inner surface. Because the point light sources 62 are disposed on the IC board 64 and are supplied power by the IC board 64, there is no need for interconnecting wires. The risk of damage to such wires is eliminated, thereby increasing the reliability of the power supply.

Referring to FIG. 7, a backlight module 70 according to a sixth embodiment of the present invention includes: a light guide plate 71 having a light incident surface 711 located at a corner thereof, and a light emitting surface 712; a point light source 72 positioned opposite to the light incident surface 711; and a light diffusing element 73 integrated with the point light source 72 and facing the light incident surface 711. The light diffusing element 73 includes a hemispherical recess 731 at a side thereof facing the light incident surface 711, and a curved surface 735 surrounding the recess 731 at said side. The curved surface 735 can further increase light emitting angles of the light radiating to the light guide plate 71. The recess 731 has a smooth inner surface.

Further alternative embodiments may include the following. The light guide plate may include two adjacent or opposite corner light incident surfaces, or even three or four corner light incident surfaces. The light guide plate may include two opposite light emitting surfaces for dual display.

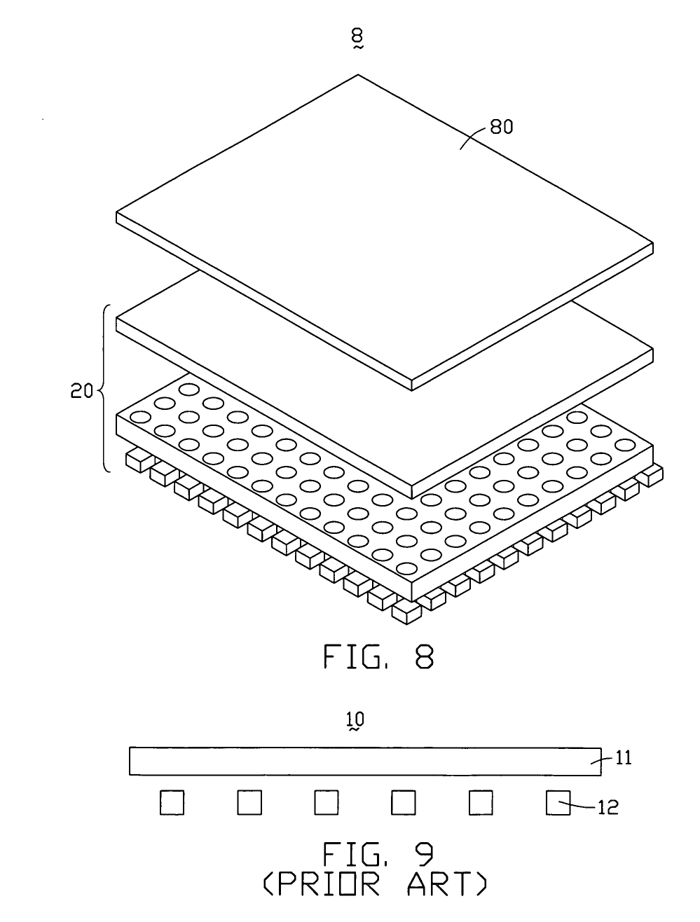

Referring to FIG. 8, a liquid crystal display 8 according to a seventh embodiment of the present invention includes a liquid crystal panel 80, and the backlight module 20 positioned adjacent the liquid crystal panel 80 for illuminating the liquid crystal panel 80. In alternative embodiments, the backlight module 20 can instead be any other backlight module as described above.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
a light guide plate having a light incident surface;
a plurality of point light sources corresponding to the light incident surface;
a transparent light diffusing element between the light guide plate and the point light sources, the light diffusing element comprising a plurality of recesses which face the light incident surface and correspond to the point light sources.

2. The backlight module as claimed in claim 1, wherein the point light sources are arrayed in a matrix.

3. The backlight module as claimed in claim 1, wherein at least one of the point light sources is a light emitting diode.

4. The backlight module as claimed in claim 1, wherein at least one of the recesses is hemispherical.

5. The backlight module as claimed in claim 1, wherein at least one of the recesses has an inner surface.

6. The backlight module as claimed in claim 5, wherein the inner surface is smooth.

7. The backlight module as claimed in claim 1, wherein the light diffusing element is made from titanium oxide (TiO₂).

8. The backlight module as claimed in claim 1, further comprising an integrated circuit board having the point light sources disposed thereon for supplying power to the point light sources.

9. A backlight module comprising:
a light guide plate having a light incident surface;
a single point light source corresponding to the light incident surface;
a transparent light diffusing element between the light guide plate and the single point light source, the light diffusing element comprising a recess which faces the light incident surface and corresponds to the point light source.

10. The backlight module as claimed in claim 9, wherein the recess is semicylindrical.

11. The backlight module as claimed in claim 9, wherein the recess has an inner surface.

12. The backlight module as claimed in claim 11, wherein the inner surface is smooth.

13. The backlight module as claimed in claim 11, wherein the recess further has a plurality of protrusions symmetrically disposed at the inner surface.

14. The backlight module as claimed in claim 13, wherein the recess defines a semicircular cross-section, and heights of the protrusions as measured from the inner surface are in the range from 0.3˜0.5 times a radius of the semicircular cross-section.

15. The backlight module as claimed in claim 9, wherein the light diffusing element further comprises an oblique portion at at least one corner thereof defined by at least one side surface and a light receiving surface of the light diffusing element.

14. The backlight module as claimed in claim 9, wherein the point light source is integrated with the light diffusing element.

15. The backlight module as claimed in claim 9, wherein the light diffusing element further comprises a curved surface surrounding the recess for further increasing light emitting angles of the light radiating to the light guide plate.

16. A liquid crystal display comprising:
a liquid crystal panel; and
a backlight module for illuminating the liquid crystal panel, the backlight module comprising a light guide plate having a light incident surface, a plurality of point light sources corresponding to the incident surface, and a transparent light diffusing element between the light guide plate and the point light sources, the light diffusing element comprising a plurality of recesses which face the incident surface and correspond to the point light sources.
